(19) United States
(12) Patent Application Publication
(10) Pub. No.: US 2020/0109951 A1
(43) Pub. Date: Apr. 9, 2020

(54) METHOD FOR LOCATING A VEHICLE

(71) Applicant: Robert Bosch GmbH, Stuttgart (DE)

(72) Inventors: Tobias Strauss, Obersulm (DE); Carsten Hasberg, Ilsfeld-Auenstein (DE)

(21) Appl. No.: 16/590,777

(22) Filed: Oct. 2, 2019

(30) Foreign Application Priority Data
Oct. 9, 2018 (DE) 102018217194.7

(51) Int. Cl. G01C 21/30; G06K 9/00; G06F 16/29

(52) U.S. Cl. CPC G01C 21/30; G06F 16/29; G06K 9/00791

(57) ABSTRACT

A method for operating a vehicle includes the following: providing a first map, a reference map and a first transformation map, the first transformation map including at least one location-dependent first transformation of poses of the first map onto corresponding poses of the reference map; ascertaining a first pose of the vehicle in relation to the first map; and transforming the first pose onto the reference map with the aid of a first transformation.

### RELATED APPLICATION INFORMATION

The present application claims priority to and the benefit of German patent application no. 10 2018 217 194.7, which was filed in Germany on Oct. 9, 2018, the disclosure of which is incorporated herein by reference.

### FIELD OF THE INVENTION

The present invention relates to a method for locating a vehicle.

### BACKGROUND INFORMATION

A method for ascertaining a vehicle position of a vehicle to be located within a predefined driving range in a mapped environment is discussed in laid-open document DE 10 2012 016 800 A1. The vehicle position is determined by evaluating position data from at least one predefined component of the vehicle. The position data are supplied by a plurality of position-detection sensors, which are permanently situated inside the mapped environment.

From the laid-open document DE 10 2016 117 123 A1, a method is discussed for locating an automated vehicle; in this case, a location of the vehicle is determined on the basis of information from radar observations and other navigation-related data.

### SUMMARY OF THE INVENTION

One objective of the present invention is to provide an improved method for locating a vehicle. This objective may be achieved by a method for locating a vehicle having the features of the independent claim. Advantageous further developments are set forth in the further descriptions herein.

A method for locating a vehicle includes the following method steps: A first map, a reference map and a first transformation map are supplied. The first transformation map includes at least one location-dependent first transformation of poses of the first map onto corresponding poses of the reference map. A first pose of the vehicle in relation to the first map is ascertained. Using a first transformation, the first pose is transformed onto the reference map.

In an advantageous manner, the present method allows for a consistent localization of the vehicle despite possible deviations between the first map and the reference map. Instead of adapting the first map itself in relation to the reference map, the present method thus simply considers in which way the first pose is able to be converted from a coordinate system of the first map to a coordinate system of the reference map. In this way, an adaptation of the first map to the reference map or an adaptation of the reference map to the first map is able to be dispensed with.

In one specific embodiment, the first transformation includes a translation and/or a rotation. On account of the translation and/or the rotation, complex and location-dependent deviations between the first map and the reference map are advantageously able to be compensated for.

In one specific embodiment, the present method includes the following additional method step prior to the ascertainment of the first pose of the vehicle. The first map and the first transformation map are updated. Updating the first map and the first transformation map advantageously ensures that the first map may still be used in a way that is consistent with the reference map when an adaptation of the first map has taken place.

In one specific embodiment, the provision of the first transformation map encompasses the following method steps: A further map, a further transformation map and an additional transformation map are provided. The further transformation map includes at least one location-dependent further transformation of poses of the first map onto corresponding poses of the further map. The additional transformation map includes at least one location-dependent additional transformation of poses of the further map onto corresponding poses of the reference map. The first transformation map is provided by linking the further transformation map with the additional transformation map.

The first transformation map may advantageously be provided without having to map it if the further transformation map and the additional transformation map are available.

In one specific embodiment, a plurality of maps and a plurality of transformation maps associated with the maps are provided. Each transformation map includes at least one location-dependent transformation of poses of the associated map onto corresponding poses of the reference map in each case. A plurality of poses of the vehicle is ascertained. Each pose relates to one map in each case. Each pose is transformed onto the reference map using an associated transformation.

This allows for a multimodal localization, i.e. a localization based on a plurality of localization systems of the vehicle. The plurality of maps may include localization maps, for instance. A localization map, for example, may be developed as a radar localization map, a camera localization map or as a lidar localization map. Each of these localization maps includes features that are developed as map-specific signatures and that are able to be detected by a map-specific sensor unit of the vehicle. This makes it possible to ascertain a plurality of poses of the vehicle, an ascertained pose relating to a localization map in each case.

In one specific embodiment, the present method includes the following further method step: An overall pose is ascertained by fusing the plurality of poses. In an advantageous manner, an ascertainment of the overall pose makes it possible to improve the accuracy of the localization of the vehicle.

In one specific embodiment, the fusing of the plurality of poses takes place by forming a weighted mean value. During the localization of the vehicle, an accuracy of an ascertained pose is advantageously able to be taken into account by the weighted mean value formation. A more precise overall pose is able to be ascertained as a result.

The afore-described characteristics, features and advantages of this invention and also the manner in which they are achieved are understood more clearly and easily in the context of the following description of the exemplary embodiments that are described in greater detail in connection with the drawing. The figures show schematic illustrations.

### BRIEF DESCRIPTION OF THE DRAWINGS

FIG. 1 show method steps of a method for locating a vehicle.

FIG. 2 show a schema of the present method.

FIG. 3 show a provision of a first transformation map according to a further development of the present method.

FIG. 4 show a schema of the present method according to an additional further development.

### DETAILED DESCRIPTION

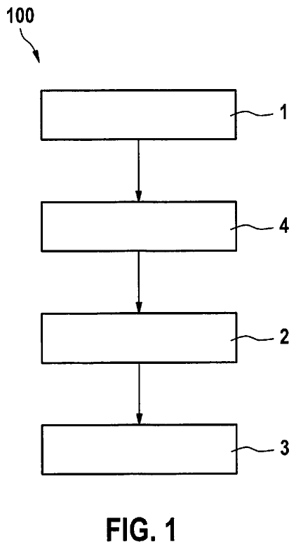

FIG. 1 shows method steps of a method 100 for locating a vehicle.

The vehicle may be any vehicle. For example, the vehicle may be developed as an automated vehicle. The automated vehicle is controllable by an automatic driving function. In the following description, the vehicle is always referred to as automated vehicle. However, the following description is not restricted to the automated vehicle and thus also applies to the vehicle in general.

To allow for the utilization of existing map information during the operation of the automated vehicle, it is necessary to locate the automated vehicle on a map. For instance, this may be accomplished with the aid of GPS or DGPS (differential GPS). In the process, the automated vehicle is located on a planning map. Additional localization maps are normally employed in order to increase the accuracy and availability of the localization. A localization map includes features in an environment of the automated vehicle that are able to be detected with the aid of a sensor unit of the automated vehicle. This makes it possible to locate the automated vehicle with the aid of the sensor unit. A localization map, for instance, may be developed as a radar localization map, as a camera localization map or as a lidar localization map. A radar localization map includes features developed as radar signatures, which are able to be detected with the aid of a radar sensor unit of the automated vehicle. A camera localization map includes features that may be detected using a camera of the automated vehicle. A lidar localization map includes features that are developed as lidar signatures, which are able to be detected using a lidar sensor unit of the automated vehicle.

One precondition for utilizing multiple maps when locating the automated vehicle is that different maps are aligned with one another. If individual maps were produced by different manufacturers, then it is possible that the maps are not aligned with one another. An alignment of the maps may then not be easily possible. For instance, it may be that no shared reference is able to be selected, or is to be selected, for the maps. Even if all manufacturers do their best to produce correct maps, deviations may occur as a result of different optimization methods. In addition, it may happen that no access is given to data of a map in order to carry out an alignment.

Method 100 for locating the automated vehicle in FIG. 1 offers the possibility of combining different maps with one another during the localization of the automated vehicle and to compensate for deviations between the different maps without having to align the maps. This allows for a consistent localization of the automated vehicle.

In a first method step 1 of method 100, a first map, a reference map and a first transformation map are provided. For example, the first map may be a localization map. However, the first map could also be a planning map. The reference map, for instance, may be the planning map. However, the reference map could also be a localization map.

The first transformation map includes at least one location-dependent first transformation of poses of the first map onto corresponding poses of the reference map. A first transformation map thus transforms a pose of the first map onto a corresponding pose of the reference map. The first transformations, for instance, may include a translation and/or a rotation in each case. However, the first transformations may also include other operations. For instance, the first transformations may also include scaling. Thus, a first transformation is a coordinate transformation from a coordinate system of the first map into a coordinate system of the reference map. In a special case, the first transformation map may include a location-independent first transformation for all poses.

In general, the first transformations are location-dependent. In different areas of the first transformation map, the first transformations may thus have a different development, the reason being that differences between the first map and the reference map may result on account of location-dependent systematic deviations.

In a second method step 2, a first pose of the automated vehicle in relation to the first map is ascertained. The first pose is made up of a position and an orientation of the automated vehicle. The position and the orientation relate to the first map in this case. If the first map is a localization map, then the first pose may be ascertained in that at least one feature that is included in the first map is detected with the aid of a sensor unit of the automated vehicle. This makes it possible to ascertain the position and the orientation of the automated vehicle in relation to the at least one feature, whereby the first pose in relation to the first map is ascertained. If the first map is the planning map, then the first pose is able to be ascertained with the aid of GPS or DGPS, for example, provided the planning map is aligned in a globally correct manner.

In a third method step 3, using a first transformation, the first pose is transformed onto the reference map. Instead of adapting the first map itself in relation to the reference map, method 100 thus only considers how the first pose may be converted from the coordinate system of the first map to the coordinate system of the reference map. In this way, a consistent localization of the automated vehicle is able to be realized in an advantageous manner despite the first map and the reference map possibly deviating from each other.

In an optional fourth method step 4 of method 100, prior to ascertaining the first pose of the automated vehicle, the first map and the first transformation map are updated. By updating the first map and the first transformation map, it can advantageously be ensured that the first map may be used in a way that is consistent with the reference map when an adaptation of the first map has taken place. Fourth method step 4 may also be omitted.

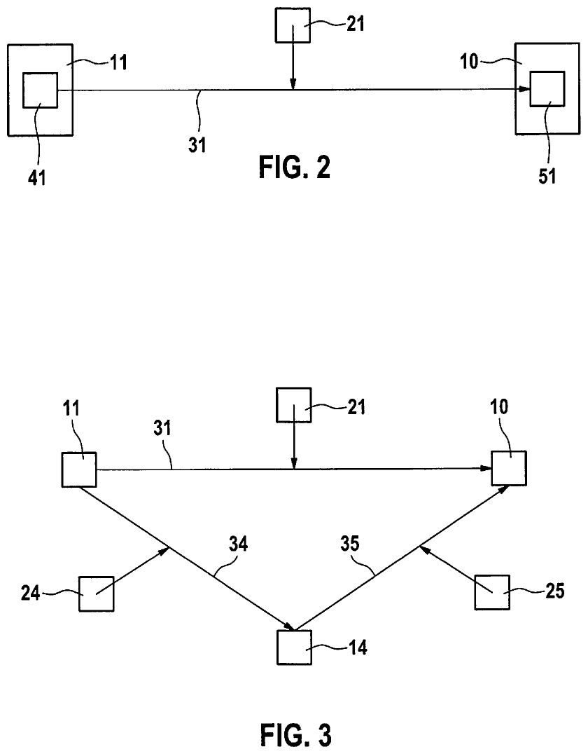

FIG. 2 shows a schema of method 100 of FIG. 1.

After the provision of first map 11, reference map 10 and first transformation map 21, which includes the location-dependent first transformations 31 of poses of first map 11 onto corresponding poses of reference map 10, first pose 41 of the automated vehicle is ascertained. Since first pose 41 is related to first map 11, first pose 41 in FIG. 2 is shown situated within first map 11. First pose 41 is then transformed onto reference map 10, whereby a transformed first phase 51 is ascertained. The transformation of first pose 41 is carried out with the aid of a first transformation 31, which is included in first transformation map 21. The transformed first phase 51 is related to reference map 10.

FIG. 3 schematically illustrates the provision of first transformation map 21 according to a further development of method 100, the provision of first transformation map 21 including additional method steps.

The provision of first transformation map 21 includes the provision of a further map 14, a further transformation map 24 and an additional transformation map 25. Further transformation map 24 includes at least one location-dependent further transformation 34 of poses of first map 11 onto corresponding poses of further map 14. Additional transformation map 25 includes at least one location-dependent additional transformation 35 of poses of additional map 14 onto corresponding poses of reference map 10. The provision of first transformation map 21 is realized by linking further transformation map 24 with additional transformation map 25. In the process, further transformations 34 are linked with additional transformations 35, thereby ascertaining first transformations 31.

Further transformations 34 and additional transformations 35, for example, may include a translation and/or a rotation in each case. However, further transformations 34 and additional transformations 35 may also include other operations. For example, the further transformations 34 and additional transformations 35 may also include scaling. Optionally, an updating of further map 14, further transformation map 24 and additional transformation map 25 may also take place prior to the ascertainment of first pose 41 of the automated vehicle.

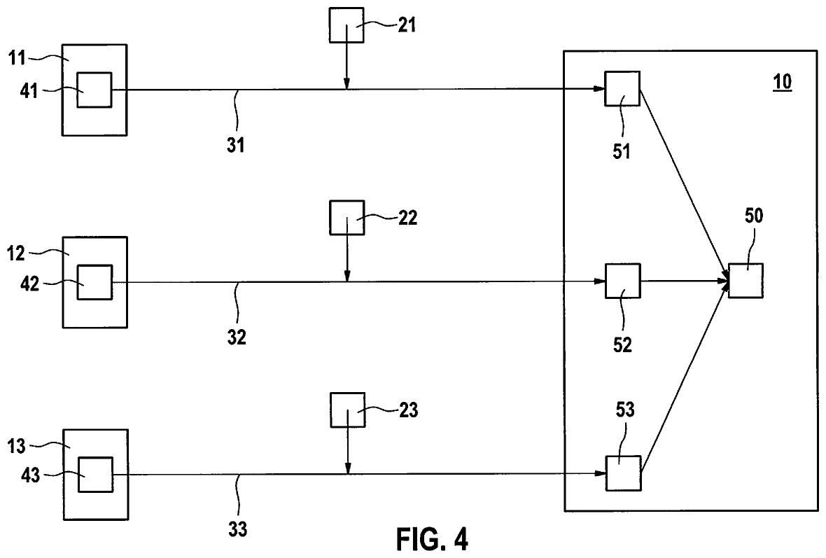

FIG. 4 shows a schema of method 100 according to a further development.

In the process, a plurality of maps 11, 12, 13 and a plurality of transformation maps 21, 22, 23 associated with maps 11, 12, 13 are provided. Each transformation map 21, 22, 23 includes at least one location-dependent transformation 31, 32, 33 of poses of associated map 11, 12, 13 onto corresponding poses of reference map 10 in each case. A plurality of poses 41, 42, 43 of the automated vehicle is ascertained. Each pose 41, 42, 43 relates to a respective map 11, 12, 13. Each pose 41, 42, 43 is transformed onto reference map 10 using an associated transformation 31, 32, 33. A plurality of transformed positions 51, 52, 53 in relation to reference map 10 is ascertained in this manner.

By way of example, the additional further development of method 100 in FIG. 4 is illustrated with the aid of three maps 11, 12, 13 and three associated transformation maps 21, 22, 23. However, any plurality of maps 11, 12, 13 and transformation maps 21, 22, 23 may be used.

Transformations 31, 32, 33, for example, may include a translation and/or rotation in each case. However, transformations 31, 32, 33 may also include other operations. For example, transformations 31, 32, 33 may include scaling as well. Optionally, an updating of maps 11, 12, 13 and transformation maps 21, 22, 23 prior to ascertaining poses 41, 42, 43 of the automated vehicle may also be carried out.

First map 11, for instance, may be the radar localization map. In this case, the ascertaining of first pose 41 is carried out using at least one feature that is included in radar localization map 11. This feature is able to be detected by the radar sensor unit of the automated vehicle. This makes it possible to ascertain first phase 41 of the automated vehicle in relation to the at least one feature included in radar localization map 11, whereby first pose 41 in relation to radar localization map 11 is ascertained.

A second map 12, for example, may be the lidar localization map. In this case, a second pose 42 is ascertained based on at least one feature that is included in lidar localization map 12. This feature is able to be detected using the lidar sensor unit of the automated vehicle. In this way it is possible to ascertain second pose 42 of the automated vehicle in relation to the at least one feature included in lidar localization map 12, whereby second pose 42 in relation to lidar localization map 12 is ascertained.

A third map 13, for instance, may be the camera localization map. In this case, a third pose 43 is ascertained based on at least one feature that is included in camera localization map 13. This feature is able to be detected using the camera of the automated vehicle. This makes it possible to ascertain third pose 43 of the automated vehicle in relation to the at least one feature included in camera localization map 13, whereby third pose 43 in relation to camera localization map 13 is ascertained.

Reference map 10 may be a planning map, for example. The use of other maps is also possible, however. One of maps 11, 12, 13 may also be the planning map. Reference map 10 may also be one of localization maps 11, 12, 13. The use of other localization maps is possible as well.

Each pose 41, 42, 43 relates to one of maps 11, 12, 13. Each pose 41, 42, 43 is transformed onto reference map 10 with the aid of an associated transformation 31, 32, 33. A plurality of transformed positions 51, 52, 53 in relation to reference map 10 is ascertained in this way.

In an optional method step, an overall pose 50 is able to be ascertained by fusing the plurality of poses 41, 42, 43. This allows for a consistent localization of the automated vehicle. For example, the fusing of the plurality of poses 41, 42, 43 may be realized by a weighted mean value formation. Forming the weighted mean value of poses 41, 42, 43 is able to improve the accuracy of the localization of the automated vehicle. For example, an accuracy of the respective localization methods may be taken into account in order to weight the individual poses 41, 42, 43. It is also possible to consider a reliability of a localization method, for instance. It may be the case, for example, that a sensor unit is temporarily unable to be used during the operation of the automated vehicle. An obstacle such as a truck, for instance, may be located within a detection range of the camera and thus make a reliable localization more difficult. This is able to be taken into account in the weighted mean value formation.

In addition to the weighted mean value formation, other methods for fusing the plurality of poses 41, 42, 43 may also be used in order to ascertain overall pose 50. For example, a filter-based method is able to be used. A Kalman filter, for instance, may be used to fuse poses 41, 42, 43. Optimization-based methods, too, are able to be employed for fusing poses 41, 42, 43. An optimization-based method, for example, may include a graph optimization.

Method 100 for locating a vehicle is not restricted to automated vehicles. Method 100 is also able to be used for locating non-automated vehicles. For example, method 100 may make it possible to provide a driver of a non-automated vehicle with driving information that is accurate down to a traffic lane. Method 100 is also able to be used for a lane change-recommending system of a non-automated vehicle, for example.

What is claimed is:

1. A method for locating a vehicle, the method comprising:
providing a first map, a reference map and a first transformation map, the first transformation map including at least one location-dependent first transformation of poses of the first map onto corresponding poses of the reference map;
ascertaining a first pose of the vehicle in relation to the first map; and
transforming the first pose onto the reference map with the aid of a first transformation.

2. The method of claim 1, wherein the first transformation includes a translation and/or a rotation.

3. The method of claim 1, further comprising:
updating, prior to ascertaining the first pose of the vehicle, the first map and the first transformation map.

4. The method of claim 1, wherein the providing of the first transformation map includes:
providing a further map, a further transformation map, and an additional transformation map, wherein the further transformation map includes at least one location-dependent further transformation of poses of the first map onto corresponding poses of the further map, and wherein the additional transformation map includes at least one location-dependent additional transformation of poses of the further map onto corresponding poses of the reference map; and
providing the first transformation map by linking the further transformation map with the additional transformation map.

5. The method of claim 1, wherein a plurality of maps and a plurality of transformation maps associated with the maps are provided, wherein each of the transformation maps includes at least one location-dependent transformation of poses of the associated map onto corresponding poses of the reference map, a plurality of poses of the vehicle being ascertained, and each pose relating to a map in each case, each pose being transformed onto the reference map with the aid of an associated transformation.

6. The method of claim 5, further comprising:
ascertaining an overall pose by fusing the plurality of poses.

7. The method of claim 6, wherein the fusing of the plurality of poses takes place by forming a weighted mean value.
